(19) United States
(12) Patent Application Publication
(10) Pub. No.: US 2014/0213718 A1
(43) Pub. Date: Jul. 31, 2014

(54) HYBRID ACRYLIC POLYURETHANE PRE-POLYMER AND SEALANT THEREON

(71) Applicant: ILLINOIS TOOL WORKS, INC., Glenview, IL (US)

(72) Inventors: Mona Kulkarni, Hyderabad (IN); Nagesh Chitnavis, Hyderabad (IN); Subodh Deshpande, Andhra Pradesh (IN)

(21) Appl. No.: 13/842,750

(22) Filed: Mar. 15, 2013

(30) Foreign Application Priority Data
Jan. 30, 2013 (IN) 411/CHE/2013

(51) Int. Cl. C09J 175/04

(52) U.S. Cl. CPC C09J 175/04
USPC 524/506; 525/102; 525/100

(57) ABSTRACT

Pre-polymer materials suitable for the preparation of superior sealants are provided along with silylated (silane terminated) hybrid acrylic polyurethane pre-polymers, and the preparation thereof, and sealants comprising the pre-polymers, and the preparation of the sealants are also provided. A silylated acrylic polyurethane hybrid pre-polymer of acrylic pre-polymer, and polyurethane including acrylic pre-polymer and a second component, which may be a silylated polyurethane (SPUR) or may be a mixture of an isocyanate, a polyol, and a silane is also provided. In a specific embodiment, the silylated hybrid acrylic polyurethane pre-polymer includes an acrylic pre-polymer, and a silylated polyurethane (SPUR).

### CROSS-REFERENCE TO RELATED APPLICATIONS

This application is a non-provisional application that claims priority benefit of Indian Provisional Application Serial No. 411/CHE/2013, filed Jan. 30, 2013 the contents of which are hereby incorporated by reference.

### FIELD OF THE INVENTION

The present invention relates to silylated hybrid pre-polymers, with improved mechanical properties, sealants prepared using the same and processes for producing the pre-polymers and sealants. The silyl terminated hybrid sealants of this invention can be successfully used in many applications such as transportation, construction and fenestration, window glazing, and high rise window application.

### BACKGROUND OF THE INVENTION

Sealants have been commonly employed for meeting the sealing and bonding requirements in many industries, for example, construction, automotive, and aerospace industries, to reinforce the structural strength of the substrate on which the sealant is applied. Desirable properties of sealants include insolubility, corrosion resistance, adhesion, etc. High mechanical properties such as tensile strength, elongation, and lap shear strength are desired for sealants used in applications such as transportation and construction.

Sealant compositions that are available today are mainly based on mono chemistries like silicone, polyurethane, acrylic, etc. In the sealant industry, polyurethane sealants dominate the transportation segment with about 70% market share, whereas reactive silicone sealants come in at a distance second. Acrylic sealants play a small role in the transportation segment as an interior caulking material because of their limitations for dynamic joint movement, and therefore command only about 2.1% of the market share. The primary reason for the small acrylic market share is the lack of existence of reactive technology.

Polyurethane and silicon sealants are often referred to as high performance sealants in that they provide significant adhesion, movement capability, and durability. However polyurethane and silicon sealants have certain disadvantages that can limit their use. In the case of polyurethane, the presence of free isocyanates, poor hydrolysis resistance, etc., renders them undesirable for some applications, whereas poor paintability, low tear resistance, and high cost make silicones unsuitable for many applications. Similarly, acrylic sealants lack the initial green strength, movement capability, and also their tack free time and full cure time are found to be inferior as compared to other type of sealants.

U.S. Pat. No. 4,345,053 to Rizk et al. discloses silicone terminated polyurethane polymer, U.S. Pat. No. 6,124,387 to Wang et al. discloses fast cure silylated polymer adhesive, U.S. Pat. No. 3,627,722 to Seiter discloses composition polyurethane sealant containing trialkoxysilane end groups, etc. Silylated polyrurethane (SPUR) based sealants are commercially available, and a few of them are used in construction and transportation segments. However, SPUR based sealants have numerous shortcomings such as high skin over and tack free time, health concerns over toxicity, and sensitizing properties of functional monomers and polymers, low green strength as well as ultimate strength, inadequate shelf life (6 months maximum), limited thermal stability, and low ultimate lap shear strength, etc. Thus, there is a need for a pre-polymer material suitable for preparing sealants which will substantially alleviate the difficulties associated with the currently known sealants, and provide superior mechanical and bonding properties with a rapid build of green strength as compared to commercially available sealants, which is cost effective as well. Further, there is a need for a sealant composition that will have adequate shelf life, stability on aging with high strength without hampering other properties, and which is more environmental friendly. There is a further need for a better process for the preparation of a superior pre-polymer and sealant with all the properties as mentioned above.

### SUMMARY OF THE INVENTION

The present invention provides pre-polymer materials suitable for the preparation of superior sealants, which overcome the problems associated with the prior art. Accordingly this invention provides silylated (silane terminated) hybrid acrylic polyurethane pre-polymers, and the preparation thereof, and sealants comprising the pre-polymers, and the preparation of the sealants, etc. An embodiment of the present invention provides a silylated acrylic polyurethane hybrid pre-polymer of acrylic pre-polymer, and polyurethane comprising acrylic pre-polymer and a second component, which may be a silylated polyurethane (SPUR) or may be a mixture of an isocyanate, a polyol, and a silane. In a specific embodiment, the silylated hybrid acrylic polyurethane pre-polymer of the present invention comprises an acrylic pre-polymer, and a silylated polyurethane (SPUR).

In another embodiment, the invention relates to a silylated hybrid acrylic polyurethane pre-polymer comprising an acrylic pre-polymer, an isocyanate, a polyol and a silane. In a further aspect of the invention, the hybrid acrylic polyurethane pre-polymer of the invention further comprises an initiator, a plasticizer, an antioxidant, a UV stabilizer, and optionally a solvent. In another aspect, the hybrid acrylic polyurethane pre-polymer of the invention further comprises a catalyst. In an embodiment, the silylated hybrid pre-polymer comprises the acrylic pre-polymer in an amount of 30 to 80 percent by weight, the silylated polyurethane (SPUR) in an amount of 20 to 50 percent by weight, the initiator in an amount of 0.01 to 1 percent by weight, the catalyst in an amount of 0.01 to 3 percent by weight, the plasticizer in an amount of 1 to 15 percent by weight, the antioxidant in an amount of 0.1 to 1 percent by weight, the UV stabilizer in an amount of 0.5 to 1.5 percent by weight, and the solvent in an amount of 0 to 5 percent by weight. In another aspect the silylated hybrid pre-polymer, as per the invention, comprises the acrylic pre-polymer in an amount of 30 to 80 percent by weight, the isocyanate in an amount of 1 to 10 percent by weight, the silane in an amount of 1 to 5 percent by weight, the polyol in an amount of 10 to 60 percent by weight, the initiator in an amount of 0.01 to 1 percent by weight, the plasticizer in an amount of 5 to 20 percent by weight, the antioxidant in an amount of 0.1 to 1 percent by weight, the UV stabilizer in an amount of 0.5 to 1.5 percent by weight, and the solvent in an amount of 0 to 5 percent by weight.

Another important aspect of embodiments of the invention relates to a process for preparing a silylated hybrid acrylic polyurethane pre-polymer. The process for preparing a silylated hybrid acrylic polyurethane pre-polymer includes in situ grafting of silylated polyurethane on the backbone of acrylic polymer by the steps of reacting an acrylic pre-polymer with a polyol and the initiator, adding an isocyante to the reaction mixture leading to the formation of acrylic urethane hybrid pre-polymer, and adding a silane to the reaction mixture.

In an embodiment of the invention, a sealant composition of a pre-polymer and a catalyst is provided, wherein the pre-polymer is selected from a preformed silylated hybrid acrylic polyurethane pre-polymer that includes an acrylic pre-polymer, an isocyanate, a polyol, a silane, an initiator, and further components such as a plasticizer, an antioxidant, a UV stabilizer and optionally a solvent and a hybrid pre-polymer, where the hybrid pre-polymer includes acrylic pre-polymer and a preformed silylated polyurethane (SPUR). In an embodiment, the sealant composition further comprises a filler, an adhesion promoter and a moisture scavenger. A sealant composition used in specific embodiments of the invention may include an acrylic pre-polymer, a preformed silylated polyurethane (SPUR), a catalyst, a filler, an adhesion promoter, and a moisture scavenger. Another sealant composition used in specific embodiments of the invention include a preformed silylated hybrid acrylic polyurethane pre-polymer, which includes an acrylic pre-polymer, an isocyanate, a polyol, a silane, an initiator, and further components like a plasticizer, an antioxidant, a UV stabilizer, and optionally a solvent, a catalyst, a filler, an adhesion promoter, and a moisture scavenger. In another embodiment the sealant composition includes the silylated hybrid acrylic polyurethane pre-polymer in an amount of 25 to 80 percentage by weight, the catalyst in an amount of 0.01 to 3 percent by weight, the filler in an amount of 5 to 30 percentage by weight, the adhesion promoter in an amount of 0.5 to 2 percentage by weight, and the moisture scavenger in an amount of 0.5 to 2 percentage by weight. Another sealant composition of the invention includes an acrylic pre-polymer, a pre formed silylated polyurethane (SPUR), and a catalyst which further includes a filler, a plasticizer, an antioxidant, a UV stabilizer, an adhesion promoter, a moisture scavenger, and optionally a solvent. In an embodiment, the sealant includes the acrylic pre-polymer present in an amount of 30 to 80 percent by weight, the silylated polyurethane (SPUR) present in an amount of 20 to 50 percent by weight, the initiator present in an amount of 0.01 to 1 percent by weight, the catalyst present in an amount of 0.01 to 3 percent by weight, the filler present in an amount of 5 to 30 percent by weight, the adhesion promoter present in an amount of 0.5 to 2 percent by weight, the moisture scavenger is present in an amount of 0.5 to 2 percent by weight, the plasticizer present in an amount of 1 to 15 percent by weight, the antioxidant is present in an amount of 0.1 to 1 percent by weight, the UV stabilizer present in an amount of 0.5 to 1.5 percent by weight, and the solvent is present in an amount of 0 to 5 percent by weight.

Embodiments of the invention provide a process for preparing a sealant composition comprising a silylated hybrid polyurethane acrylic pre-polymer, where the process may be selected from: a) a blending process wherein a filler, an adhesion promoter, a moisture scavenger and a catalyst are mixed with a preformed silylated hybrid acrylic polyurethane pre-polymer comprised of an acrylic pre-polymer, an isocyanate, a polyol, and a silane, further including an initiator, a plasticizer, an antioxidant, a UV stabilizer, and optionally a solvent; and b) in situ grafting of silylated polyurethane on the back bone of acrylic pre-polymer by the steps of adding an initiator, antioxidant, filler, and a UV stabilizer to the acrylic pre-polymer, reacting the reaction mixture with a silylated polyurethane pre-polymer adding a catalyst to the reaction mixture leading to formation of silylated acrylic polyurethane hybrid pre-polymer, and adding a filler, an adhesion promoters, a moisture scavenger to the reaction mixture. In another embodiment of the process for preparing a sealant composition includes a silylated hybrid polyurethane acrylic pre-polymer comprises the step of blending wherein a filler, an adhesion promoter, a moisture scavenger and a catalyst are mixed with a preformed silylated hybrid acrylic polyurethane pre-polymer including an acrylic pre-polymer, an isocyanate, a polyol and a silane, and further including an initiator, a plasticizer, an antioxidant, a UV stabilizer, and optionally a solvent. In another embodiment, the process for preparing a sealant composition includes a silylated hybrid polyurethane acrylic pre-polymer including in situ grafting of silylated polyurethane on the back bone of acrylic pre-polymer by the steps of adding an initiator, antioxidant, filler, and UV stabilizer to the acrylic pre-polymer, and reacting the reaction mixture with a sylilated polyurethane pre-polymer, adding a catalyst to the reaction mixture leading to formation of sylilated acrylic polyurethane hybrid pre-polymer, and adding a filler, an adhesion promoters, a moisture scavenger to the reaction mixture.

Embodiments of the inventive composition overcomes the problems of the prior art. In particular, the silylated polymers and the sealants based thereon developed as per this invention exhibit outstanding performance properties, and are found to be cost effective as well. Additionally, the sealant composition has shown exceptional stability on aging, exhibiting high strength without hampering other properties. Furthermore, the sealant of the present invention exhibits optimal performance/properties due to synergy between elastomeric polymers of different classes. Tensile and lap shear strength are found to be good even after aging the sample at 50° C. for 2 week, indicating that the shelf life of the invented composition is longer than 9-10 months. It is further observed that, since isocyanate functional free molecules are coupled with excess of silane molecules, embodiments of the inventive sealant contains very low amount of VOC free solvent, which makes the sealants more environmental friendly.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification are to be understood as being modified in all instances by the term “about”. It is noted that, unless otherwise stated, all percentages given in this specification and appended claims refer to percentages by weight of the total composition.

Thus, before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

It is also noted that, as used in this specification and the appended claims, the singular forms “a,”, “an” and “the” include plural referents unless the content clearly dictates otherwise. Thus, for example, reference to a “filler” may include two or more such fillers. Unless defined otherwise, all technical and scientific terms used herein have the same meaning as commonly understood by one of ordinary skill in the art to which the invention pertains.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The pre-polymer of embodiments of the present invention is a silicon terminated hybrid pre-polymer of polyurethane and acrylic pre-polymer. The term pre-polymer as used herein, defines a monomer or system of monomers that have been reacted to an intermediate molecular weight state. The pre-polymer material is capable of further polymerization by reactive groups to a fully cured high molecular weight state. As such, mixtures of reactive polymers with un-reacted monomers may also be referred to as pre-polymers. Polyurethane (PU) as used herein may be defined as polymer composed of a chain of organic units joined by carbamate (urethane) links. Polyurethane polymers are formed by reacting an isocyanate with a polyol. Both the isocyanates and polyols used to make polyurethanes contain on average two or more functional groups per molecule. Polyols as used herein may be defined as compounds with multiple hydroxyl functional groups available for organic reactions. A molecule with two hydroxyl groups is a diol, one with three is a triol, one with four is a tetrol and so on. Monomeric polyols such as glycerin, pentaerythritol, ethylene glycol, and sucrose often serve as the starting point for polymeric polyols. Polymeric polyols are generally used to produce other polymers. Polymeric polyols are reacted with isocyanates to make polyurethanes. Polymeric polyols are usually polyethers or polyesters. Common polyether diols are polyethylene glycol, polypropylene glycol, and poly (tetramethylene ether) glycol. Polyether polyols account for about 90% of the polymeric polyols used industrially; the balance is polyester polyols. Reactive polyols as per the invention have hydroxyl functionality, which on reacting with a stoichiometric excess of a polyisocyanate provides NCO terminated polyurethane pre-polymer. Suitable polyols operative herein illustratively include polyalkylene glycols, such as polyether having molecular weight from 500 to 6000, and combinations thereof. The polyol is typically present in the pre-polymer composition in an amount from about 10 to 60% by weight, in other embodiments from about 12 to 55% by weight, and even more preferably from about 15 to 50% by weight.

Isocyanates used in embodiments may be diisocyanates or polyisocyanates having two or more isocyante (—NCO) moieties per molecule. Polyisocyanate may include any suitable isocyanate having at least two isocyanate groups illustratively including, aliphatic-, aromatic-, cycloaliphatic-, arylaliphatic-arylalkyl-, alkylaryl-isocyanates, and mixtures thereof. Suitable diisocyanate functional monomers operative herein illustratively include 2,4-toluene diisocyanate (TDI), 2,6toluene diisocyanate, 4,4′ diphenylmethylene diisocyanate (MDI), isophorone diisocyanate, dicyclohexyl-methane diisocyanate, various liquid diphenylmethylene diisocyanates containing 2,4-and 4,4′ isomers, etc., and mixtures thereof. The isocyanate monomer is typically present in the pre-polymer composition in an amount from about 1 to 10% by weight, in other embodiments from about 2 to 9% by weight, and even more preferably from about 3 to 9% by weight.

According to embodiments of the invention, the pre-polymer is a silylated pre-polymer. Silylation or silicon termination may be defined as the introduction of a (usually) substituted silyl group (R₃Si) to a molecule. The process involves the replacement of a proton with a trialkylsilyl group (—SiR₃).

Silanes as used herein are defined as saturated compounds that consist only of hydrogen and silicon atoms that are bonded exclusively by single bonds. Each silicon atom has 4 bonds (either Si—H or Si—Si bonds), and each hydrogen atom is joined to a silicon atom (H—Si bonds). A series of linked silicon atoms is known as the silicon skeleton or silicon backbone. The number of silicon atoms is used to define the size of the silane (e.g., Si₂-silane). A silyl group is a functional group or side-chain that, like a silane, consists solely of single-bonded silicon and hydrogen atoms, for example a silyl (—SiH₃) or disilanyl group. The simplest possible silane (the parent molecule) is silane, SiH₄.

Silanes used herein also may be organofunctional silanes of formula Y—R—Si—(R¹)m(—OR²)₃ₘ (2), where Y is a hydroxyl group or a primary or secondary amino group and R¹ and R² are the same or different, monovalent, optionally substituted hydrocarbon groups which comprise between 1 and 12 carbon atoms, and can be interrupted with heteroatoms. Silanes operative herein illustratively include mercapto silane, Silquest A-15, A-35, epoxy silane, isocyanate silane, vinyl silane, thiocyanato silane, phenyl silane, and the like. The silane is typically present in the pre-polymer and sealant composition in an amount from about 1 to 5% by weight, in other embodiments from about 1.2 to 4.8% by weight, and even more preferably from about 1.5 to 4.5% by weight.

Silylated poluurethane (SPUR) is also commercially available, examples of which include Desmoseal 2458, 2636, 2662, and the like. In one embodiment, SPUR is present in the pre-polymer and sealant composition in an amount from about 20 to 50% by weight, in other embodiments from about 22 to 48% by weight, and even more preferably from about 23 to 45% by weight.

According to an embodiment of the invention, the hybrid pre-polymer of the present invention includes at least one acrylic pre-polymer which reacts to form the base polymer. Acrylic pre-polymer functions as a basic binder. The invention contemplates the employment of linear or non-linear acrylates. Suitable acrylic pre-polymers may be derived by polymerizations of various acrylic monomers. Standard well known methods are used for the preparation of acrylic pre-polymers. Representative of such acrylic pre-polymers are those disclosed in US Patent Application Publication US2009/0098388 to Harvey et al., the contents of which are hereby incorporated by reference. Acrylic pre-polymer is commercially available under the trade name AR-27 by Schnee Morehead. The acrylic pre-polymer is typically present in the pre-polymer and sealant compositions in an amount from about 30 to 80% by weight, in other embodiments from about 35-75% by weight, and even more preferably from about 38-70% by weight.

The polymerization process is initiated by the addition of a free radical generating initiator. Free radical polymer initiators are well known to those of skill in the art, and are selected based on the speed, temperature, catalytic target, and the like. Initiators operative herein illustratively include tert-butyl hydroperoxide (TBHP), tert-butyl peroxybenzoate (TBPB), and cumene hydroperoxide (CHP). The initiator is present in an amount sufficient to provide the desired rate of polymerization. Typically, the initiator is added in an amount of from about 0.01 to 1% by weight, in other embodiments in an amount of from about 0.01 to 0.08% by weight, and in other embodiments in an amount of about 0.01 to 0.05% by weight.

The sealant composition of embodiments of the present invention is a hybrid sealant composition. The sealant composition encompassed by the present invention incorporate a silylated pre-polymer system composed of a hybrid polyurethane acrylic pre-polymer in combination with other additives.

The term “sealant”, as used herein, defines a polymer material that becomes solid once it is applied with sufficient adhesion to the substrate. Sealants offer resistance to environmental conditions to remain bonded over the required life of the assembly. When sealants are used between substrates having different thermal co-efficients of expansion or differing elongation under stress, the sealants must exhibit adequate flexibility and elongation properties. The present invention has utility as a sealant for bonding like or disparate substrates. In hybrid sealants the backbone of one sealant family is combined with the reactive groups typically positioned at the polymer terminals of another sealant polymer type. Hybrid sealants are of increasing interest because they can be formulated to provide the best properties of two or more families of polymeric materials while limiting their individual inherent weaknesses.

According to another embodiment of the invention, the sealant composition of the present invention contains at least one filler. Filler increases abrasion resistance, strength, tenacity and viscosity. Fillers employed in the present invention include hydrophobic fillers which are employed as reinforcing agents or rheology modifier. The chemical composition of the filler, and its particle size, morphology, and particle size distribution of the filler are rationally selected to confer desirable physical properties to the composition. Examples of fillers that are operative herein illustratively include fumed silica, colloidal silica, calcite, limestone, mica, talc, asbestos fibers or powder, diatomaceous earth, carbon black, metal particulate, barium sulfate, alumina, slate flour, calcium silicate, magnesium carbonate, magnesium silicate, and the like. The filler is present in the composition in an amount of about 5 to 30% by weight, in other embodiments from about 8 to 28% by weight, and in still other embodiments from about 10 to 25% by weight.

The sealant composition of embodiments of the present invention also includes a catalyst to accelerate the reaction between the acrylic pre-polymer and polyisocyanate, hydrolytic cleavage of the hydrolyzable groups of the silane grouping, as well as, the subsequent condensation of the Si—OH group to form siloxane groupings (crosslinking reaction) or a combination thereof. The catalyst is preferably stable and does not contribute to unwanted side reactions, particularly during manufacture, transportation, or storage of the sealant material. Suitable catalysts illustratively include organic metallics, stannous salts of carboxylic acids, tin organo-metallics, and the like. In accordance to the present invention, the preferred catalyst is a tin catalyst, for e.g., dibutyltin dilaurate. The catalyst is typically present in an amount of from about 0.01 to 3% by weight, in other embodiments in an amount of from about 0.05 to 2.8% by weight, and in still other embodiments in an amount of about 0.05 to 2.5% by weight.

The sealant composition of the present invention optionally includes at least one plasticizer that functions as an extender or improves plasticity and fluidity of the composition. The plasticizers used in embodiments of the invention illustratively includes tris(2-ethylhexyl)trimellitate (TOTM), trimethyl pentanyl diisobutyrate (TXIB), phthalate free C₁-C₂₀ alkylsulphonic acid ester with phenol, benzoate ester, mesamoll and combinations thereof. The plasticizer present in the composition in a total amount from about 1 to 20% by weight, in other embodiments in an amount of from about 1 to 15% weight, and in other embodiments in an amount of about 5 to 20% by weight.

An antioxidant is optionally present in an embodiment of the inventive composition. An antioxidant prevents thermal degradation and offers long term stability, and increases thermal stability of the composition. Antioxidants operative herein illustratively include ditri decyl thiodipropionate (DTDTDP), dilauryl thiodipropionate (DLTDP), distearyl thiodipropionate (DSTDP) and 3,5-Bis(1,1dimethylethyl)-4-hydroxybenzenepropanoic acid octadecyl ester (1076), and Tris(2,4-di-tertbutylphenyl)phosphite (168), and combinations thereof. Typically, an antioxidant is added in an amount of from about 0.1 to 1% by weight, in specific embodiments in an amount of from about 0.2 to 0.98% and in other embodiments in an amount of about 0.3 to 0.98% by weight.

The sealant composition of embodiments of the present invention may also optionally include one of, or both of, an adhesion promoter and a moisture scavenger. An adhesion promoter increases the ability of the composition to bond to various substrates. Useful adhesion promoters operative herein illustratively include 3-aminopropyl triethoxy silane (AMEO), 3-aminopropyl trimethoxy silane, 3-glycidoxypropyltrimethoxysilane, N-(beta-aminoethyl) gamma aminopropyltrimethoxysilane DAMO, AMMO, 1120 and combinations thereof thereof. It is appreciated that an amino silicone in combination with a monomeric diisocyanate in the composition readily forms an adhesion promoting complex. TDI is exemplary of such diisocyanates. It is also appreciated that in addition to the above-mentioned exemplary monomeric adhesion promoters, polymer adhesion promoters are operative herein, and illustratively include maleic anhydride modified polymers of polypropylene (PP) styrene; maleic anhydride copolymers of PP, styrene and methyl vinyl ether; polyorganosiloxanes; polyorganosilanes; and combinations thereof.

Moisture scavengers are water bonding agents (electro withdrawing nature) added to enhance shelf stability of moisture sensitive products. The moisture scavengers operative herein illustratively include methyldiphenylethoxysilane; vinyl trimethoxy silane (VTMO), vinyl triethoxy silane; acid anhydride esters such as diethyl malonate and dimethyl succinate; and combinations thereof. Both the adhesion promoter and moisture scavenger, if present, are typically in an amount of from about 0.5 to 2% by weight for each as individual or combinations of compounds, in other embodiments from about 0.6 to 1.8% by weight and, if present, in other embodiments in an amount of about 0.8 to 1.75% by weight.

The sealant composition of the present invention optionally includes UV stabilizers. A UV stabilizer imparts resistance against UV radiation. Examples of UV stabilizers are benzotriazoles, benzophenones, triazines, hindered amine light stabilizers, 2-(benzotriazol-2-yl)-4-(2,4,4trimethylpentan-2-yl) phenol, 3,5-di-t-butyl-4-hydroxybenzoic acid, hexadecyl ester and combinations thereof. The UV stabilizers, if present, is typically in an amount of from about 0.5 to 1.5% by weight, in other embodiments from about 0.6 to 1.4% by weight and in still other embodiments in an amount of about 0.65 to 1.3% by weight.

The sealant composition of embodiments of the present invention optionally includes sufficient solvent to have a desirable viscosity at room temperature, and to be applied to a substrate under ambient conditions. Preferably, the solvent employed in accordance with the present invention is free from VOCs (volatile organic compounds). It is appreciated that other non-VOC solvents are also operative herein, and are optionally present at levels of reduced regulatory concerns. VOC exempt solvents operative herein illustratively include dimethylcarbonate, propylene carbonate and tetra butyl acetate, and the like. The solvent is present in an amount of from about 0 to 5% by weight, in other embodiments, if present, is in an amount of from about 0 to 4.5% by weight, and in other embodiments in an amount of about 0 to 4.3% by weight.

The inventive compositions optionally include other additives conventional to the sealant art, including but not limited to, non-reactive resins, dehydrators, colorants (e.g., pigments, dyes), flame retardants, waxes, spacers, inhibitor, accelerator, and mixtures thereof. Other minor or optional components include cross linkers, inhibitors, resin, chelating agent, corrosion inhibitor, pigments, spacers, fragrance, fire retardants, accelerator, etc., may be included in the sealant composition as per this invention.

Accordingly, embodiments of the present invention provides a silylated pre-polymer comprising silane, acrylic pre-polymer, a polyol, and an isocyanate with further and optional components. The present invention also provides a silylated pre-polymer including silylated polyurethane and acrylic pre-polymer with further and optional components. The present invention further discloses a sealant composition including a silylated hybrid acrylic pre-polymer with further and optional components. The present invention also discloses a sealant composition including an acrylic pre-polymer and SPUR with further and optional components.

In another important aspect of embodiments of the present invention relates to a process for preparing the silylated hybrid pre-polymer including acrylic pre-polymer, polyurethane, and sealants based thereon. In a specific aspect of the process for preparing a silylated hybrid pre-polymer including acrylic pre-polymer and polyurethane may be carried out by an in situ grafting of silylated polyurethane on the backbone of acrylic polymer, which includes the steps of reacting an acrylic pre-polymer with a polyol and an initiator, adding an isocyante to the reaction mixture resulting in the formation of acrylic urethane hybrid pre-polymer, and then adding a silane to the reaction mixture resulting in the silylation of the acrylic urethane hybrid pre-polymer.

Embodiments of the invention provide a process for preparing a sealant comprising the above mentioned silylated acrylic urethane hybrid pre-polymer which includes a blending process wherein a filler, an adhesion promoter, a moisture scavenger, and a catalyst are mixed with the silylated hybrid pre-polymer. In a still further embodiment this invention also relates to another process for preparing a sealant including an in situ grafting of silylated polyurethane on the back bone of acrylic pre-polymer. The process includes the steps of adding an initiator, antioxidant, filler, and UV stabilizer to the acrylic pre-polymer, reacting the reaction mixture with a sylilated polyurethane pre-polymer, adding a catalyst to the reaction mixture leading to formation of sylilated acrylic polyurethane hybrid pre-polymer, and adding a filler, an adhesion promoter, a moisture scavenger, etc. to the reaction mixture resulting in the formation of a sealant including silylated acrylic polyurethane pre-polymer.

The processes as mentioned above may further include the steps of adding other additives conventional to the sealant art including, but not limited to, non-reactive resins, dehydrators, colorants (e.g., pigments, dyes), flame retardants, waxes, spacers, inhibitor, accelerator, and mixtures thereof, and the steps of adding other minor or optional components like cross linkers, inhibitors, resin, chelating agent, corrosion inhibitor, pigments, spacers, fragrance, fire retardants, accelerator, etc.

According to a specific aspect, an exemplary composition of silylated hybrid pre-polymer as per the current embodiment of the invention was prepared which has the following characteristics as in table 1.

TABLE 1

| Properties: | Silylated hybrid pre-polymer |
|---|---|
| Chemistry: | Silane terminated acrylic + PU |
| Appearance: | Clear yellow liquid |
| Paintable: | Yes |
| Nonvolatiles (%): | 95~100% |
| Viscosity (Brookfield #5 @ | 80,000-120,000 cps |
| 5 rpm): | |
| Glass transition temp Tg | Minus 45~57° C. |

According to a further aspect of the invention, an exemplary composition was subjected to various tests to evaluate the performance of the inventive hybrid sealant composition. Accordingly, tests were conducted to evaluate the physical properties such as thermal stability, hardness, tensile and lap shear strength and elongation. Thermal Stability test: Sealants samples were kept at 50°+/−1° C. for 2 weeks. Result: No change in viscosity was observed during test period. Tensile and lap shear strength were tested after keeping the sample at 50° C. for 2 week. Result: These parameters were found to be good even after ageing indicating that the shelf life of the invented composition is more than 9-10 months.

The properties are shown in the below table 2.

TABLE 2

| | Sealant formulation | | Sealant | |
|---|---|---|---|---|
| | using commercially | | formulation using | |
| | available SPUR and | | Silylated hybrid | |
| Properties | AR-27 pre-polymer | | pre-polymer | |
| Slump (in) | NIL | | NIL | |
| Skin over Time | 10 | mins | 10 | mins |
| Tack-Free Time (Minutes) | 25-30 | mins | 25-30 | mins |
| Tensile Strength (PSI) | 350 | | 315 | |
| Elongation (%) | 500 | | 575 | |
| Durometer, Shore A | 38 | | 40 | |
| Green Strength after 24 hrs | 90 | | 106 | |
| Stability at high temp @ 50° C. | 2 | weeks | 2 | weeks |

The sealant provided by embodiments of the present invention provide the following advantages: the product has shelf life of a year at 250 C; free of trapping and release of carbon dioxide; easy to use for end applications; the product cures fast and possesses excellent thermal stability over a wide temperature range; demonstrates outstanding tensile strength, green strength and lap shear strength. Furthermore, the sealants in the present invention exhibit superior mechanical and adhesion properties, and exhibits excellent adhesion to substrates including Glass, Wood, CRS, Aluminum, PVC, ABS, MS, vinyl, and fiberglass.

Any patents or publications mentioned in this specification are herein incorporated by reference to the same extent as if each individual publication was specifically and individually indicated to be incorporated by reference.

The foregoing description is illustrative of particular embodiments of the invention, but is not meant to be a limitation upon the practice thereof. The following claims, including all equivalents thereof, are intended to define the scope of the invention.

1. A silylated hybrid acrylic polyurethane pre-polymer comprising:
an acrylic pre-polymer; and
a component selected from one of: a silylated polyurethane (SPUR) or a mixture of an isocyanate, a polyol and a silane.

2. A silylated hybrid acrylic polyurethane pre-polymer of claim 1 consisting of said acrylic pre-polymer, said silylated polyurethane (SPUR) and a catalyst.

3. A silylated hybrid acrylic polyurethane pre-polymer of claim 1 consisting of said acrylic pre-polymer, said silylated polyurethane (SPUR), a catalyst, and an initiator.

4. A silylated hybrid acrylic polyurethane pre-polymer of claim 1 consisting of said acrylic pre-polymer, said silylated polyurethane (SPUR), a catalyst a plasticizer, an antioxidant, a UV stabilizer and optionally a solvent.

5. A silylated hybrid acrylic polyurethane pre-polymer of claim 1 consisting of said acrylic pre-polymer, said silylated polyurethane (SPUR), a catalyst, an initiator, a plasticizer, an antioxidant, a UV stabilizer and optionally a solvent.

6. The hybrid pre-polymer of claim 5 wherein said acrylic pre-polymer is present in an amount of 30 to 80 percent by weight, said silylated polyurethane (SPUR) is present in an amount of 20 to 50 percent by weight, said initiator is present in an amount of 0.01 to 1 percent by weight, said catalyst 0.01 to 3 percent by weight, said plasticizer is present in an amount of 1 to 15 percent by weight, said antioxidant is present in an amount of 0.1 to 1 percent by weight, said UV stabilizer is present in an amount of 0.5 to 1.5 percent by weight, and the solvent is present in an amount of 0 to 5 percent by weight.

7. A silylated hybrid acrylic polyurethane pre-polymer of claim 1 consisting of said acrylic pre-polymer and said mixture of an isocyanate, a polyol and a silane, with an initiator.

8. The silylated hybrid acrylic polyurethane pre-polymer of claim 1 consisting of said acrylic pre-polymer and said mixture of an isocyanate, a polyol and a silane, with an initiator, a plasticizer, an antioxidant, a UV stabilizer and optionally a solvent.

9. The hybrid pre-polymer of claim 8 wherein said acrylic pre-polymer is present in an amount of 30 to 80 percent by weight, the isocyanate is present in an amount of 1 to 10 percent by weight, the silane is present in an amount of 1 to 5 percent by weight, the polyol is present in an amount of 10 to 60 percent by weight, the initiator is present in an amount of 0.01 to 1 percent by weight, the plasticizer is present in an amount of 5 to 20 percent by weight, the antioxidant is present in an amount of 0.1 to 1 percent by weight, the UV stabilizer is present in an amount of 0.5 to 1.5 percent by weight and the solvent is present in an amount of 0 to 5 percent by weight.

10. A process for preparing a silylated hybrid acrylic polyurethane pre-polymer comprising:
in situ grafting of a silylated polyurethane on a backbone of an acrylic polymer by the steps of:
reacting said acrylic pre-polymer with a polyol and an initiator;
adding an isocyante to a reaction mixture leading to the formation of an acrylic urethane hybrid pre-polymer; and
adding a silane to the said reaction mixture.

11. A sealant composition comprising:
a pre-polymer and a catalyst wherein the pre-polymer is selected from one of:
a silylated hybrid acrylic polyurethane pre-polymer as claimed in claim 7; or
a hybrid pre-polymer comprising acrylic pre-polymer and a pre silylated polyurethane (SPUR).

12. The sealant composition of claim 10 further comprising a filler, an adhesion promoter and a moisture scavenger.

13. A sealant composition comprising:
a silylated hybrid acrylic polyurethane pre-polymer as claimed in claim 7 and a catalyst.

14. The sealant composition of claim 13 further comprising a filler, an adhesion promoter and a moisture scavenger.

15. The sealant composition of claim 14 wherein the silylated hybrid acrylic polyurethane pre-polymer is present in an amount of 25 to 80 parts, the catalyst is present in an amount of 0.01 to 3 percent by weight, the filler is present in an amount of 5 to 30 percent by weight, the adhesion promoter is present in an amount of 0.5 to 2 percent by weight and the moisture scavenger is present in an amount of 0.5 to 2 percent by weight.

16. A sealant composition comprising:
a hybrid pre-polymer comprising acrylic pre-polymer and a pre silylated polyurethane (SPUR) and a catalyst.

17. The sealant composition of claim 16 further comprising: a filler, an initiator, a plasticizer, an antioxidant, a UV stabilizer, an adhesion promoter, a moisture scavenger and optionally a solvent.

18. The sealant composition of claim 17 wherein the acrylic pre-polymer is present in an amount of 30 to 80 percent by weight, the silylated polyurethane (SPUR) is present in an amount of 20 to 50 percent by weight, the initiator is present in an amount of 0.01 to 1 percent by weight, the catalyst is present in an amount of 0.01 to 3 percent by weight, the filler is present in an amount of 5 to 30 percent by weight, the adhesion promoter is present in an amount of 0.5 to 2 percent by weight, the moisture scavenger is present in an amount of 0.5 to 2 percent by weight, the plasticizer is present in an amount of 1 to 15 percent by weight, the antioxidant is present in an amount of 0.1 to 1 percent by weight, the UV stabilizer is present in an amount of 0.5 to 1.5 percent by weight and the solvent is present in an amount of 0 to 5 percent by weight.

19. A process for preparing a sealant composition comprising a silylated hybrid polyurethane acrylic pre-polymer, the process selected from one of:
a blending process wherein a filler, an adhesion promoter, a moisture scavenger and a catalyst are mixed with the silylated hybrid pre-polymer as claimed in claim 7; and
in situ grafting of silylated polyurethane on a back bone of acrylic pre-polymer by the steps of
adding an initiator, antioxidant, filler and UV stabilizer to the acrylic pre polymer;
reacting the said reaction mixture with a sylilated polyurethane pre-polymer and adding a catalyst to the reaction mixture leading to formation of sylilated acrylic poly urethane hybrid pre-polymer; and
adding a filler, adhesion promoters, and a moisture scavenger to the reaction mixture.

20. A process for preparing a sealant composition comprising a silylated hybrid polyurethane acrylic pre-polymer comprising:
a blending process wherein a filler, an adhesion promoter, a moisture scavenger, and a catalyst are mixed with the silylated hybrid pre-polymer as claimed in claim 7.

21. A process for preparing a sealant composition comprising a silylated hybrid polyurethane acrylic pre-polymer, said process comprising:
in situ grafting of silylated polyurethane on a back bone of acrylic pre-polymer by the steps of:
adding an initiator, antioxidant, filler, and UV stabilizer to the acrylic pre-polymer reacting the said reaction mixture with a sylilated polyurethane pre-polymer;
adding a catalyst to a reaction mixture leading to formation of said sylilated acrylic poly urethane hybrid pre-polymer; and
adding a filler, an adhesion promoters, a moisture scavenger to the reaction mixture.
